(19) United States
(12) Patent Application Publication
(10) Pub. No.: US 2026/0359853 A1
(43) Pub. Date: Nov. 12, 2026

(54) System and Method for Dynamic Affiliate and Promotional Reward Allocation via Physical and Digital Engagement Triggers

(71) Applicant: Stephen Royal, Chicago, IL (US)

(72) Inventor: Stephen Royal, Chicago, IL (US)

(21) Appl. No.: 19/224,831

(22) Filed: Jun. 1, 2025

Related U.S. Application Data
(60) Provisional application No. 63/800,547, filed on May 6, 2025.

(51) Int. Cl. G06Q 30/0207

(52) U.S. Cl. CPC G06Q 30/0224; G06Q 30/0222; G06Q 30/0225; G06Q 30/0239

(57) ABSTRACT

A system and method for initiating affiliate and promotional interactions across physical goods, digital content, services, and time-sensitive experiences via physical and digital engagement triggers—including NFC tags, BLE beacons, QR codes, wired sensors, browser extensions, SDKs, Al-generated interfaces, outbound link interceptors, and mechanical buttons. The system supports programmable reward routing, attribution continuity, and dynamic content personalization. It enables CPC, CPA, and CPI monetization models, with a bidding engine allowing brands to compete for trigger entry points in real time. Third-party affiliate APIs are used for verification.

Fallback mechanisms support triggerless or low-tech environments through redirect wrappers, static attribution recovery, and campaign-level link resolution logic. Al-generated interactions embed affiliate links while preserving tracking integrity. White-labeled interfaces, compliance modules, and analytics dashboards enable transparent deployment across users, brands, OEMs, and platforms.

### FIELD OF THE INVENTION

The present invention relates to affiliate and promotional reward systems that utilize physical and digital engagement triggers to dynamically allocate rewards based on brand, user, or campaign context. The system encompasses browser-based, app-integrated, and AI-mediated interfaces and includes support for session continuity, brand-controlled bidding, and reward configuration workflows.

### BACKGROUND OF THE INVENTION

Conventional affiliate marketing relies heavily on static web links and browser cookies, lacking support for multi-device continuity, physical triggers, or AI-enhanced personalization. Existing systems fail to offer real-time brand control, reward routing customization, or verified attribution across platforms. Manufacturers lack tools to direct rewards, influence trigger behavior, or validate transactions across CPA/CPC/CPI models. Current frameworks provide no fallback for triggerless events and offer limited transparency into reward distribution or messaging.

Conventional affiliate marketing systems are unable to preserve attribution when user journeys pass through AI interfaces or browser-stripped links. The disclosed system solves this technical problem by introducing a persistent attribution framework that integrates token-based tracking, fallback redirection, and real-time validation modules.

The system is designed to operate independently or in conjunction with existing affiliate marketing platforms such as Amazon Associates, CJ Affiliate, or Rakuten Advertising, allowing for seamless integration with third-party tracking, commission validation, and campaign management ecosystems. The invention provides a platform for affiliate and promotional monetization using multi-modal engagement triggers and programmable reward logic. Physical triggers (e.g., NFC, BLE, QR) and software interceptors (e.g., SDKs, browser extensions) route users to landing pages, brand content, or AI-powered interfaces.

These physical trigger mechanisms may be embedded in a wide range of consumer electronics and accessories—including, but not limited to, phone cases, keychains, key trackers, eyewear, wireless speakers, earbuds, headphones, soundbars, computer peripherals (e.g., keyboards, mice, hubs), smartwatches, fitness trackers, remote controls, watch bands, charging cords, wireless charging pads, tablets, laptops, vehicle mounts, and household appliances—regardless of their specific form factor or function.

An attribution engine preserves referral integrity, while a programmable reward engine allocates value to multiple recipients (e.g., user, charity, OEM, platform) based on configurable logic. Enhancements include: manufacturer reward path configuration, real-time brand bidding, verified affiliate API integration, session-aware routing, multi-tiered fallback handling (including triggerless attribution recovery), and personalized display messaging. The platform enables new monetization pathways for brands, charities, and users across transactions involving physical goods, digital goods, service-based offerings, and time-sensitive experiences (such as event ticketing, travel, and appointments), across both physical and digital commerce environments.

The disclosed system integrates a modular architecture comprising components such as a Trigger Mechanism, Attribution Engine, Reward Routing Layer, Fallback Handler, and LLM Integration Layer. These subsystems cooperate to provide a robust, campaign-aware affiliate reward platform that dynamically processes user interactions across physical and digital entry points. Definitions for these components are provided herein to clarify their technical roles and system interdependencies.

The disclosed system and methods were conceived, developed, and filed by the named inventor prior to any employment relationship with third parties, including but not limited to entities operating in the fields of power management, IoT, or digital engagement. All technical development and conception occurred independently and without reliance on external resources or confidential information.

### SUMMARY OF THE INVENTION

The system is designed to operate independently or in conjunction with existing affiliate marketing platforms such as Amazon Associates, CJ Affiliate, or Rakuten Advertising, allowing for seamless integration with third-party tracking, commission validation, and campaign management ecosystems. The invention provides a platform for affiliate and promotional monetization using multi-modal engagement triggers and programmable reward logic. Physical triggers (e.g., NFC, BLE, QR) and software interceptors (e.g., SDKs, browser extensions) route users to landing pages, brand content, or AI-powered interfaces.

These physical trigger mechanisms may be embedded in a wide range of consumer electronics and accessories—including, but not limited to, phone cases, keychains, key trackers, eyewear, wireless speakers, earbuds, headphones, soundbars, computer peripherals (e.g., keyboards, mice), smartwatches, fitness trackers, remote controls, watch bands, charging cords, wireless charging pads, hubs, tablets, laptops, vehicle mounts, and household appliances—regardless of their specific form factor or function.

An attribution engine preserves referral integrity, while a programmable reward engine allocates value to multiple recipients (e.g., user, charity, OEM, platform) based on configurable logic. Enhancements include: manufacturer reward path configuration, real-time brand bidding, verified affiliate API integration, session-aware routing, multi-tiered fallback handling (including triggerless attribution recovery), and personalized display messaging. The platform enables new monetization pathways for brands, charities, and users across transactions involving physical goods, digital goods, service-based offerings, and time-sensitive experiences (such as event ticketing, travel, and appointments), across both physical and digital commerce environments.

The disclosed system integrates a modular architecture comprising components such as a Trigger Mechanism, Attribution Engine, Reward Routing Layer, Fallback Handler, and LLM Integration Layer. These subsystems cooperate to provide a robust, campaign-aware affiliate reward platform that dynamically processes user interactions across physical and digital entry points. Definitions for these components are provided herein to clarify their technical roles and system interdependencies.

### DEFINITIONS

Reward Engine:

A software or hardware subsystem configured to apply programmable reward logic based on campaign metadata, user/device context, and external partner inputs. The engine supports campaign-aware rule processing, audit trace logging, and real-time decision-making across multiple recipient types.
Attribution Engine:

A module that maintains referral continuity through session-aware identifiers, cross-device tracking, and fallback mapping logic, including hash-based fingerprinting and redirect validation.
Physical Trigger:

A subset of trigger mechanisms that rely on hardware-based interactions in the physical world, including but not limited to Near Field Communication (NFC) tags, Bluetooth Low Energy (BLE) beacons, QR codes, magnetic switches, or capacitive touch sensors. Physical triggers are used to initiate trackable events through proximity, tap, scan, or touch actions.
AI-Integrated Flow:

A user-initiated process where a prompt is sent to a large language model (LLM), which responds with one or more affiliate links selected from a system-injected list, coupled with a verification and redirect fallback system.
Attribution Engine:

A subsystem responsible for associating user interactions with origin triggers, sessions, or campaign metadata, using token-based tracking, session continuity modules, and fallback resolution logic.
LLM Integration Layer:

A system module that interacts with large language models (LLMs), injects context-specific affiliate metadata into prompts, verifies returned responses for valid tracking links, and implements redirect fallbacks when integrity is compromised. In some embodiments, the LLM interface is launched via a physical or digital trigger as described in FIG. 5, enabling AI-based affiliate monetization flows to originate from QR codes, NFC tags, or SDK calls.
Fallback Handler:

A rule-based mechanism that detects the absence of valid triggers or output conditions and dynamically redirects users to alternate destinations or intermediary landing pages to preserve reward routing continuity. Fallbacks include redirect wrappers, static landing pages, hashed identifier matching, fingerprint correlation, and last-known campaign context restoration to preserve reward continuity even in cases of stripped links, device incompatibility, or AI-generated omissions.
Trigger Mechanism:

A hardware or software-based system that initiates a user interaction or engagement event. Trigger mechanisms include, but are not limited to, physical triggers such as NFC tags, Bluetooth Low Energy (BLE) beacons, QR codes, capacitive buttons, magnetic switches, tactile membrane switches, and USB-plug sensors; as well as software-based triggers such as SDK calls, browser extension events, or API webhooks. These mechanisms may be embedded in physical form factors such as phone cases, wristbands, charging cords, key trackers, wearable devices, smart accessories, or household electronics, or implemented entirely within software layers. Trigger mechanisms are responsible for initiating the affiliate engagement flow and may optionally encode metadata such as campaign identifiers or session tokens at the point of activation. [0021] Reward Routing Layer: The software logic that interprets attribution outcomes and applies reward distribution logic to one or more recipients, incorporating campaign-defined rules, device context, and recipient entitlements.

### BRIEF DESCRIPTION OF THE DRAWINGS

FIG. 1—Direct Link Flow Diagram: Depicts the process flow beginning with a physical or digital trigger. The user initiates engagement through a trigger mechanism (e.g., NFC, QR, BLE, wired sensor, SDK, or browser extension). An interaction event is generated with metadata and transmitted to a remote server or cloud platform, which invokes an attribution engine. The attribution engine resolves the destination path (landing page, direct URL, or app deep link) and redirects the user, logging tracking data. The system then monitors for a qualifying event (e.g., purchase, download, or redemption), and upon verification, executes reward distribution logic.

FIG. 2—Reward Allocation Logic Tree: Illustrates how the reward engine processes interaction events. Campaign logic is parsed to determine eligible reward paths (e.g., donation, cashback, OEM share). If multiple reward paths are present, prioritization logic is applied. The system awaits confirmation of a qualifying action before dynamically allocating reward percentages to designated recipients. Interface validation with affiliate platforms (Amazon, CJ, Rakuten) ensures accurate tracking and distribution.

FIG. 3—System Architecture Diagram: Outlines the layered architecture of the system. The user initiates engagement through various trigger types. Metadata is collected and sent through backend modules including attribution, identity resolution, fallback handling, and reward logic. Requests are routed to affiliate platforms, and destination URLs with tracking tags are issued. Upon a qualifying event, rewards are allocated and verified. Interfaces to third-party platforms and internal databases are also illustrated.

FIG. 4—LLM Response Handler: Demonstrates how affiliate monetization is handled within a large language model (LLM) interface. A physical or digital trigger redirects the user to an AI-enabled environment. The user submits a query, and the LLM interprets it using contextual data and campaign metadata. Affiliate links are selected or generated and embedded into the AI response. Session tracking and attribution logic are initiated. Upon conversion, reward logic is executed and allocated to designated recipients. Fallbacks, session continuity, and attribution enforcement mechanisms are included.

FIG. 5—AI Monetization Flow: Represents the process for monetizing interactions with AI interfaces. A user initiates engagement through various trigger types. The user is redirected to an AI interface. The user submits a prompt to an LLM through a UI or widget. The AI engine parses the prompt, extracts intent, and selects associated products or offers. Contextual affiliate links are embedded in the AI output. When a user clicks a link, redirection occurs with tracking metadata intact. The engagement is mapped to a campaign, and rewards are distributed upon verifying a qualifying event.

FIG. 6—Product-Brand Mapping Table: Presents a tabular example of how affiliate reward values are mapped to specific products and manufacturers. Each entry contains a product identifier (e.g., ASIN, SKU, or UPC), product name, mapped brand, total reward value, user-directed portion (e.g., donation, cashback), and platform-retained amount. This mapping table enables brand-specific reward routing and licensing enforcement.

FIG. 7—User Flow from Trigger to Reward: Depicts the end-to-end flow from a user tapping a trigger mechanism to final reward distribution. After a trigger event is logged by the backend, attribution and campaign logic are applied. The user is redirected to a destination such as an app store or landing page. The system monitors for a qualifying action and, upon confirmation, calculates and distributes rewards. All events are logged for reporting and analytics.

### FALLBACK PATHWAY EXAMPLES

The system may invoke multiple fallback methods, depending on context:
Static Redirects: When a physical trigger fails or lacks connectivity, the system serves a preconfigured destination with embedded affiliate tracking.
Campaign Recovery Pages: For AI outputs missing affiliate links, a branded landing page offers eligible promotions with attribution tags.
Fingerprint Matching: When links are stripped, hashed fingerprints of prior sessions enable retroactive attribution.
Secondary Affiliate Routes: If an affiliate platform fails to track an event, the system reroutes the user to a backup merchant destination tied to the same campaign.
Triggerless Recovery: In cases with no user tap (e.g., clipboard or receipt parsing), logic infers the session origin from historical or contextual cues.

### DETAILED DESCRIPTION OF THE DRAWINGS

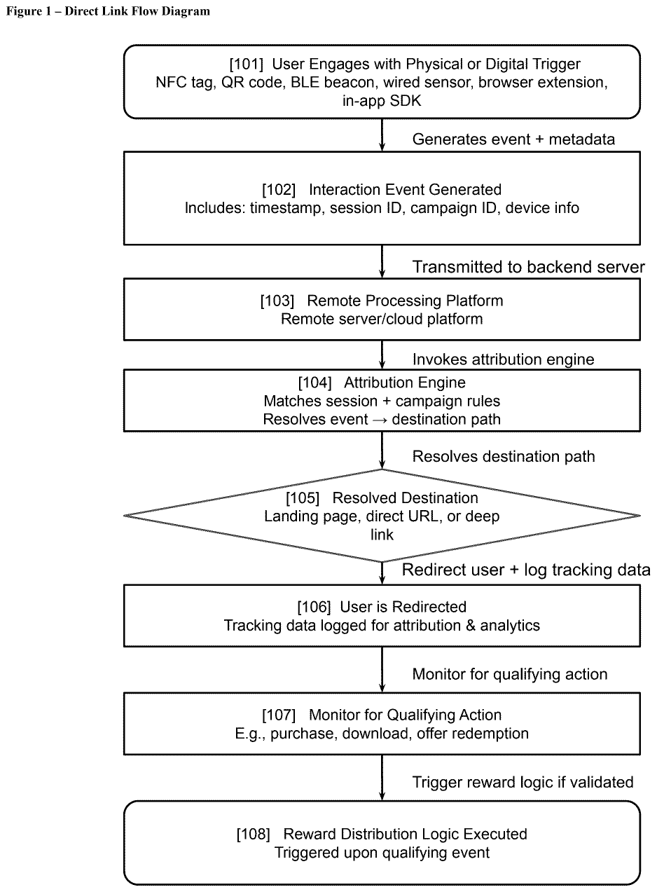

### FIG. 1—Direct Link Flow Diagram—A Mechanism That Ensures Affiliate Earnings or Commissions are Routed to Pre-Designated Brand Recipients, Even when Trigger Devices are Redistributed or Modified

At block [101], user engages with a physical or digital trigger mechanism (e.g., NFC tag, QR code, BLE beacon, wired sensor, browser extension, or in-app SDK).

At block [102] an interaction event is created, including metadata such as timestamp, session ID, campaign identifier, and device context.

At block [103] the event is transmitted to a remote server or cloud-based platform for processing.

At block [104] the server invokes an attribution engine to resolve the event into a destination path.

At block [105] based on embedded rules, the resolved destination may be a landing page, a direct URL, or a mobile app deep link.

At block [106] the user is redirected to the determined destination while tracking data is logged for attribution and analytics.

At block [107] subsequently, the system monitors for a qualifying downstream action (e.g., purchase, download, offer redemption).

At block [108] only upon confirmation of the qualifying event is reward logic triggered and processed.

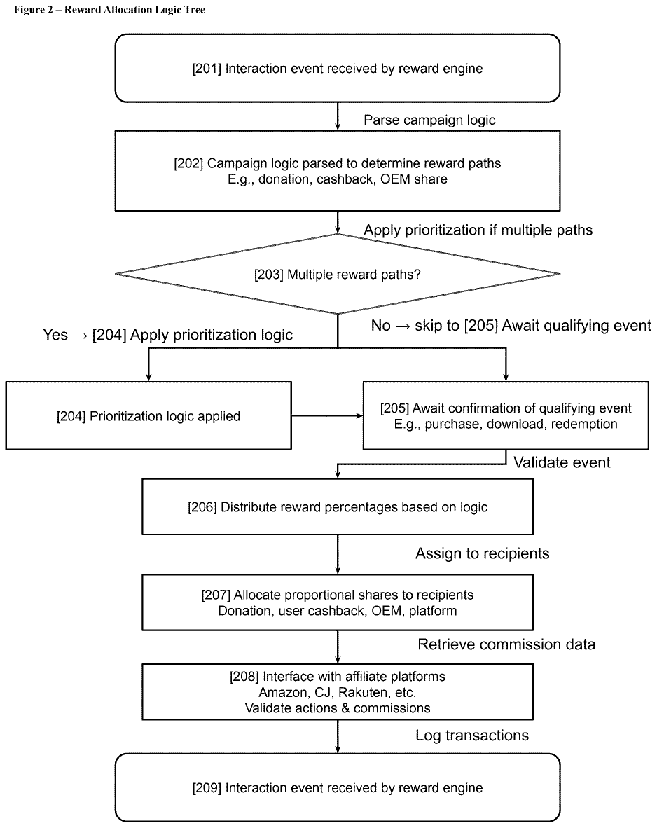

### FIG. 2—Reward Allocation Logic Tree

At block [201] an interaction event is received and processed by the reward engine.

At block [202] campaign logic is parsed to determine reward pathways (e.g., donation, cashback, OEM share).

At block [203] if the interaction qualifies for multiple reward paths, at [block 204] prioritization logic is applied.

At block [205] the reward engine awaits confirmation of a qualifying event such as a completed purchase or app download.

At block [206] upon successful validation, the selected reward distribution percentages are dynamically allocated.

At block [207] each designated recipient is assigned a proportional share of the resulting affiliate or promotional earnings.

At block [208] the system may interface with external affiliate platforms (e.g., Amazon Associates, CJ Affiliate, Rakuten Advertising) to retrieve commission data, validate qualifying actions, and confirm transaction completion.

At block [209] all reward transactions are logged for transparency and reporting.

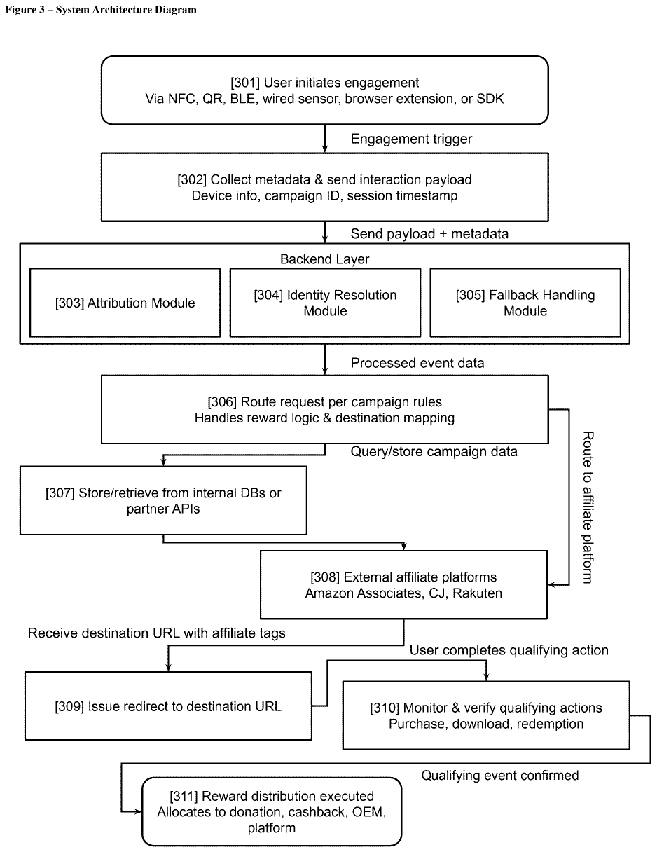

### FIG. 3—System Architecture Diagram

At block [301] the user initiates engagement through a physical or digital trigger.

At block [302] the frontend layer collects metadata and sends an interaction payload to the backend platform.

At block [303] the backend processes the event via modules including attribution, identity resolution, and fallback handling.

At block [304, 305, 306] The logic layer routes the request based on campaign rules and system logic.

At block [307] data is stored or retrieved from integrated databases or partner APIs.

At block [308] in some configurations, the system dynamically formats and routes affiliate interactions through external platforms such as Amazon Associates, CJ Affiliate, or Rakuten to ensure proper link tagging, session tracking, and commission registration.

At block [309] a redirect to a destination URL is issued.

At block [310] the system monitors for and verifies qualifying user actions, which trigger reward distribution processes.

At block [311] if attribution resolution fails, the fallback handler is triggered to preserve tracking integrity through redirect wrappers, fingerprint-based session reconstruction, or static campaign recovery pages.

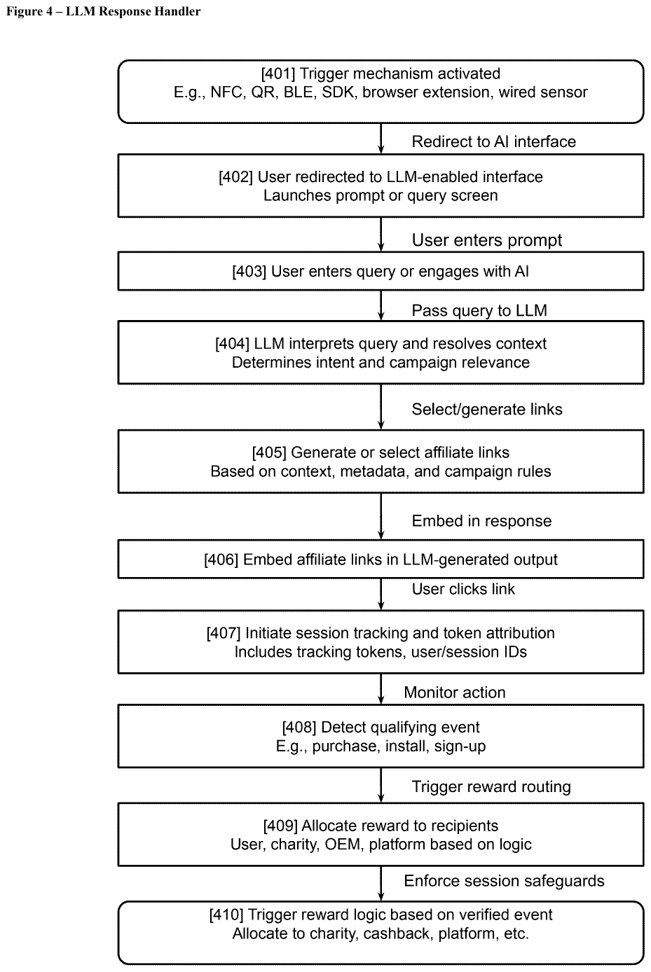

### FIG. 4—LLM Response Handler

At block [401] A physical or digital trigger mechanism is activated, such as an NFC tap, QR code scan, BLE signal, SDK call, browser extension event, or wired sensor interaction.

At block [402] The trigger redirects the user to an AI-enabled interface, launching a prompt or query environment powered by a large language model (LLM).

At block [403] The user inputs a query or engages with the AI interface.

At block [404] The LLM interprets the query and identifies the context or intent.

At block [405] The system selects or dynamically generates affiliate links based on the query, context, and campaign metadata.

At block [406] These affiliate links are embedded within the AI-generated response.

At block [407] User engagement with the embedded links initiates session tracking and token-based attribution.

At block [408] The system monitors for a qualifying conversion event, such as a purchase, install, or sign-up.

At block [409] Upon verification, the reward routing logic is invoked to allocate value to designated recipients (e.g., user, charity, OEM, platform).

At block [410] Session continuity safeguards (e.g., hashed identifiers, cross-device tracking, redirect fallback) are enforced to preserve referral integrity.

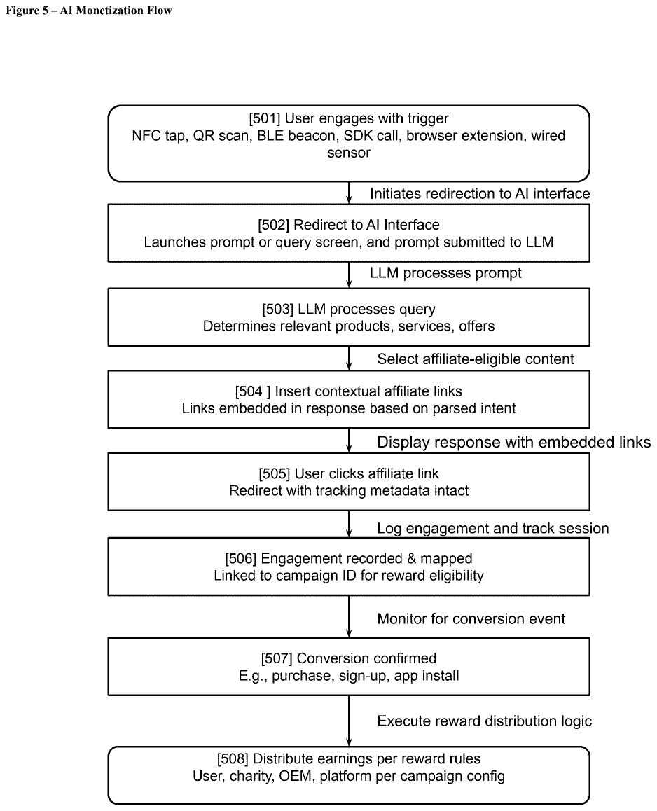

### FIG. 5—AI Monetization Flow

At block [501] A physical or digital trigger mechanism is activated-such as an NFC tap, QR code scan, BLE beacon, SDK call, browser extension event, or wired sensor interaction.

At block [502] This interaction redirects the user to an AI-enabled interface or embedded widget, where a prompt is submitted to a large language model (LLM) for processing.

At block [503] The AI engine parses the input and selects associated products, services, digital goods, and time-sensitive experiences.

At block [504] Contextual affiliate links are inserted into the AI-generated response.

At block [505] If clicked, the link redirects the user with tracking intact.

At block [506] The engagement is recorded and mapped to a campaign for reward eligibility.

At block [507] The system confirms the completion of a qualifying action before executing any reward distribution.

At block [508] Earnings are distributed per predefined reward rules and partner configurations.

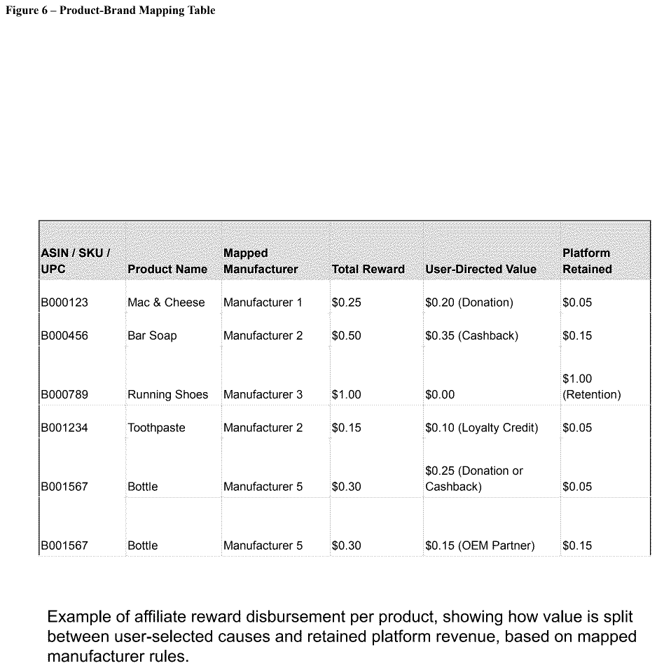

### FIG. 6—Product-Brand Mapping Table

A product interaction is detected, typically via SKU, ASIN, or other identifier.

The system queries a mapping table linking products, services, digital goods, and time-sensitive experiences to their manufacturers or brand owners.

The associated brand is resolved using deterministic or fuzzy matching logic.

This resolution determines the party eligible to receive affiliate credit or revenue share.

The result is stored and optionally used to enforce brand licensing rules or reward thresholds.

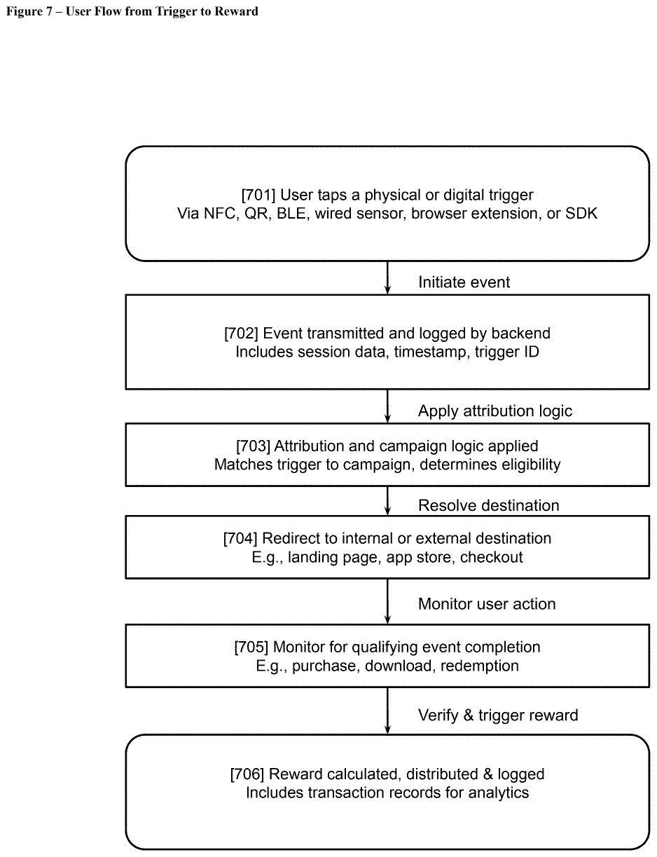

### FIG. 7—User Flow From Trigger to Reward

At block [701] User taps a trigger mechanism, initiating an event.

At block [702] The event is transmitted and logged by the backend system.

At block [703] Attribution and campaign matching is applied to determine eligibility.

At block [704] User is redirected to an external or internal destination, such as a landing page, app store, or checkout flow.

If the attribution is disrupted or tracking data is missing, the fallback handler invokes a recovery process using static redirect pages, hashed fingerprints, or inferred session logic.

At block [705] The system monitors for the completion of a qualifying action (e.g., purchase, download, redemption).

At block [70] Upon verification, reward distribution is calculated and logged for reporting and analytics.

### DETAILED DESCRIPTION

The disclosed system comprises a modular architecture designed to facilitate dynamic affiliate and promotional reward routing. Its primary components include a trigger layer, attribution engine, programmable reward engine, fallback handler, and analytics dashboard. These modules interoperate to support conversion events across a wide range of monetization models—including single-purchase, recurring subscription, hybrid physical/digital bundles, deferred-payment flows, and non-purchase interactions such as app installs, trial activations, or brand engagements.

The system accommodates transactions involving physical goods, digital content, service-based offerings, and time-sensitive experiences (e.g., event ticketing, travel bookings, or appointment scheduling). It also supports microtransactions, in-store to digital conversion tracking, and multi-step funnels.

Engagements originate from physical or digital triggers, including Near Field Communication (NFC) tags, Bluetooth Low Energy (BLE) beacons, QR codes, wired sensor inputs, browser extensions, or embedded software development kits (SDKs). Upon user interaction, the trigger launches a URL, deep link, or LLM (large language model) interface-embedding relevant tracking metadata in the process. The attribution engine receives and validates the event, preserving referral integrity through session-aware tracking mechanisms.

Following validation, the programmable reward engine determines the appropriate value allocation based on campaign metadata, session context, and brand-defined logic. Reward recipients may include charities, users, OEMs, retailers, service providers, and platform operators .. A bidding exchange may be used to rank competing reward paths in real-time, using cost-per-click (CPC), cost-per-action (CPA), or cost-per-install (CPI) models.

A product-brand mapping module links user interactions to the associated brand or manufacturer based on identifiers such as SKU, ASIN, or UPC. Concurrently, a display rendering engine governs promotional messaging based on brand preferences, regulatory restrictions, or white-label configurations.

To address potential device limitations or absent triggers, the system includes a fallback handler. This component supports attribution continuity through session fingerprinting, redirect preservation, triggerless inference models, or landing page rerouting.

The system further integrates AI-driven workflows. For instance, when a user is routed to a large language model (LLM) interface—such as ChatGPT, Claude, or another AI assistant—affiliate links are dynamically embedded within natural language responses. These may include monetized suggestions from platforms like Amazon, Walmart.com, or participating eCommerce networks. Link integrity is safeguarded through prompt injection techniques, preloaded link lists, and monitoring layers that validate the presence and structure of outbound URLs.

If a valid affiliate link is omitted by the LLM, the system automatically redirects the user to a system-controlled landing page that reintroduces attribution logic and tracks downstream engagement. Additional continuity is maintained through hashed fingerprinting, tokenized session IDs, and asynchronous attribution recovery methods.

To support secure licensing and deployment, a licensing validation subsystem ensures that only authorized OEMs or integration partners can deploy reward-enabled trigger mechanisms. Unauthorized deployments may be flagged or deactivated by a compliance engine, with real-time telemetry monitoring and license key enforcement.

In alternate embodiments, attribution metadata and qualifying conversion events may be recorded to a permissioned blockchain ledger. This immutable layer provides an auditable history of user engagements and reward allocations, facilitating dispute resolution and compliance across multi-party affiliate ecosystems.

External APIs connect to major affiliate networks for real-time conversion validation and commission retrieval. Administrative dashboards present real-time analytics, reward status, and historical audit trails-ensuring transparency, regulatory compliance, and system integrity.

While the disclosed invention may integrate with consumer electronics, smart devices, and third-party marketing platforms, its core novelty resides in the orchestration of affiliate reward attribution across diverse physical and digital trigger environments. It does not pertain to or replicate technologies focused on energy systems, power regulation, industrial control, or smart grid infrastructure.

1. A distributed system for tracking parameter integrity and recovery, comprising:
(a) one or more trigger interface modules, each configured to receive an interaction event from a physical or digital input source, including one or more of: Near Field Communication (NFC) devices, Bluetooth Low Energy (BLE) beacons, QR codes, browser-based URL interceptors, in-application SDKs, and ambient sensor interfaces, wherein each trigger interface module captures trigger metadata comprising at least a device identifier, a timestamp, and an interaction context associated with the received interaction event;
(b) a session management module executed by one or more processors and configured to:
(i) generate a session-bound identifier by applying a cryptographic hash function to a combination of the device identifier, timestamp, and interaction context captured in the trigger metadata, such that the session-bound identifier is unique to that combination;
(ii) associate subsequent user interactions across one or more computing devices with the session-bound identifier to maintain cross-device session continuity; and
(iii) store the session-bound identifier and associated trigger metadata in a non-transitory computer-readable memory;
(c) an attribution validation module executed by one or more processors and configured to:
(i) detect corruption, omission, or unauthorized modification of tracking parameters embedded within an outbound link generated during a session associated with the session-bound identifier by comparing expected tracking parameter structures stored in the non-transitory computer-readable memory against actual tracking parameters present in the outbound link;
(ii) determine a failure state when tracking structure one or more tracking parameters present in the outbound link deviate from the expected tracking parameter structures, or one or more expected tracking parameters are absent from the outbound link; and
(iii) generate a failure state record comprising the session-bound identifier and identifying the one or more tracking parameters that are corrupted, omitted, or modified;
(d) a fallback routing module executed by one or more processors and configured to:
(i) receive the failure state record from the attribution validation module;
(ii) use the session-bound identifier in the failure state record to retrieve, from the non-transitory computer-readable memory, the trigger metadata stored in association with the session-bound identifier;
(iii) reconstruct, from the retrieved trigger metadata, the one or more tracking parameters identified in the failure state record; and
(iv) automatically redirect a user device to a destination resource using a corrected outbound link incorporating the reconstructed tracking parameters, without requiring user input; and
(e) a data processing module executed by one or more processors and configured to communicate attribution validation results, session continuity data, and failure state records to one or more external systems via an application programming interface (API).

2. The system of claim 1, further comprising a reward distribution module configured to: (a) support dynamic routing rules based on device type, trigger category, campaign metadata, user profile data, or external partner configuration; (b) allocate reward amounts as fixed, percentage-based, or tiered values; and (c) override or redirect allocations in real-time based on campaign rules, inventory status, or time-based events.

3. (canceled)

4. (canceled)

5. (canceled)

6. The system of claim 1, further comprising an interoperability module configured to maintain attribution and session state across mobile applications, desktop browsers, and connected devices.

7. (canceled)

8. The system of claim 1, further comprising a fraud detection subsystem configured to: (a) detect anomalous usage or traffic, (b) flag suspicious attribution chains, (c) suppress invalid payouts, and (d) log risk assessments for manual or automated review.

9. (canceled)

10. The system of claim 1, wherein the data processing module is configured to communicate with affiliate or eCommerce networks through an API or feed integration for the purpose of: (a) SKU-level transaction validation, (b) referral tracking resolution, and (c) conversion-based reward reconciliation.

11. (canceled)

12. (canceled)

13. (canceled)

14. (canceled)

15. (canceled)

16. (canceled)

17. (canceled)

18. The system of claim 1, wherein: (a) a physical or digital trigger initiates user redirection to an LLM interface, and a predefined list of affiliate links is injected into the LLM prompt at the time of query initiation, based on the trigger metadata, campaign context, or user profile; (b) the LLM is configured to generate one or more natural language responses referencing product or service categories; and (c) any product or service references within the response are linked using one or more of the preloaded affiliate links, thereby enabling affiliate tracking and monetization upon user engagement.

19. The system of claim 1, further comprising a large language model (LLM) interface executed by one or more processors and configured to:
(a) receive, during the session associated with the session-bound identifier, a natural-language user input and a curated list of affiliate links, each affiliate link in the curated list comprising tracking parameters;
(b) provide the natural-language user input and the curated list of affiliate links to an LLM:
(c) receive from the LLM a natural-language response including at least one outbound affiliate link selected from the curated list;
(d) cause the attribution validation module to compare the tracking parameters actually present in the at least one outbound affiliate link against the expected tracking parameter structures; and
(e) upon determination of the failure state, cause the fallback routing module to reconstruct the one or more tracking parameters and automatically redirect the user device using the corrected outbound link.

20. The system of claim 19, wherein:
(a) the tracking parameters actually present in the at least one outbound affiliate link identify at least one of:
(i) the physical or digital input source that generated the interaction event;
(ii) the session-bound identifier; or
(iii) campaign metadata included in the trigger metadata stored in association with the session-bound identifier; and
(b) the session management module uses the session-bound identifier to establish an association between user engagement with the at least one outbound affiliate link and the interaction event.

21. The system of claim 19, wherein the LLM interface is further configured to:
(a) cause the LLM to semantically analyze the natural-language user input;
(b) cause the LLM to select a contextually appropriate affiliate link from the curated list;
(c) receive the natural-language response in which the selected affiliate link is embedded in human-readable format; and
(d) cause the attribution validation module to verify that the selected affiliate link contains tracking parameters conforming to the expected tracking parameter structures.

22. (canceled)

23. (canceled)

24. (canceled)

25. (canceled)

26. (canceled)

27. (canceled)

28. The system of claim 19, wherein the at least one outbound affiliate link is routed through a signed redirect wrapper, and wherein, when one or more tracking parameters in the at least one outbound affiliate link are modified or stripped by the LLM, the fallback routing module uses the session-bound identifier to retrieve the trigger metadata stored in association with the session-bound identifier, reconstructs the modified or stripped tracking parameters from the retrieved trigger metadata, and automatically redirects the user device through the signed redirect wrapper using the corrected outbound link.

29. (canceled)

30. (canceled)

31. The system of claim 19, wherein the one or more processors are further configured to:
(a) generate a respective hashed identifier for each affiliate link in the curated list of affiliate links;
(b) store, in the non-transitory computer-readable memory, an association among each respective hashed identifier, the session-bound identifier, and the physical or digital input source; and
(c) upon user engagement with the natural-language response when the response lacks direct tracking metadata, match an affiliate link engaged by the user device to the physical or digital input source using the stored association.

32. The system of claim 19, wherein the one or more processors are further configured to:
(a) verify that the natural-language response includes at least one outbound affiliate link having tracking parameters corresponding to the physical or digital input source or to campaign metadata included in the trigger metadata;
(b) upon detecting omission, corruption, or invalid formatting of the tracking parameters, cause the fallback routing module to use the session-bound identifier to retrieve the associated trigger metadata and reconstruct one or more tracking parameters; and
(c) automatically redirect the user device to a system-controlled landing page using a corrected outbound link incorporating the reconstructed tracking parameters.

33. The system of claim 1, further comprising a reward distribution module configured to apply campaign-specific prioritization rules based on user segmentation, partner tiers, or real-time traffic signals.

34. The system of claim 1, wherein session continuity is maintained using a hashed identifier generated from device fingerprint, trigger type, and timestamp metadata.

35. The system of claim 1, further comprising a reward distribution module configured to adjust allocations based on the originating trigger type, such that physical triggers receive elevated weighting compared to digital links.

36. (canceled)

37. (canceled)
